(19) United States
(12) Patent Application Publication
(10) Pub. No.: US 2012/0056950 A1
(43) Pub. Date: Mar. 8, 2012

(54) METHOD FOR PRODUCING LIQUID EJECTING RECORDING HEAD

(75) Inventors: Koichi Igarashi, Kanagawa (JP); Shogo Ono, Kanagawa (JP); Manabu Tomita, Kanagawa (JP); Minoru Kohno, Tokyo (JP); Shigeru Ushiki, Saitama (JP); Shohei Makita, Saitama (JP)

(73) Assignees: TAIYO INK MFG. CO., LTD, Saitama (JP); SONY CORPORATION, Tokyo (JP)

(21) Appl. No.: 13/295,329

(22) Filed: Nov. 14, 2011

Related U.S. Application Data
(63) Continuation of application No. 11/460,336, filed on Jul. 27, 2006.

(30) Foreign Application Priority Data
Aug. 8, 2005 (JP) 2005-229865

(51) Int. Cl. B41J 2/175; B23P 17/00

(52) U.S. Cl. 347/85; 29/890.1

(57) ABSTRACT

A liquid ejecting recording head using a flow duct material which includes an oxetane resin composition that contains, as necessary components, an oxetane compound having at least one oxetanyl group in a molecule, and a cationic photopolymerization initiator.

### RELATED APPLICATION DATA

This application is a continuation of U.S. patent application Ser. No. 11/460,336, filed Jul. 27, 2006, the entirety of which is incorporated herein by reference to the extent permitted by law. The present application claims priority to Japanese Patent JP 2005-229865 filed in the Japanese Patent Office on Aug. 8, 2005, the entirety of which also is incorporated by reference herein to the extent permitted by law.

### BACKGROUND OF THE INVENTION

This invention relates to a flow duct forming material for a recording head of the liquid ejecting type which exhibits low stress and high resistance against chemicals and which includes a plural number of flow ducts formed to high accuracy by patterned shaping by e.g. radiation of ultraviolet light.

### DESCRIPTION OF RELATED ART

Among the liquid ejecting type recording heads, there is an ink jet recording head applied to the ink jet recording system, ejecting e.g. the ink as liquid (liquid jet recording system). This ink jet recording head includes several constituent units, namely a plural number of ejecting orifices (orifices) ejecting the ink in a finely divided form, a plural number of flow ducts communicating with these ejecting orifices, and by a plural number of ink ejecting pressure generating devices, provided in certain portions of the flow ducts. For generating a high quality image with such ink jet recording head, it is preferred that small ink droplets, discharged from the ejecting orifices, are discharged with the same volume and at the same ejecting speed at all times from the respective ejecting orifices.

Among the ink jet recording heads, realizing these ejecting conditions, there are those stated for example in the following Patent Publication 1 (JP Laid-Open Patent Publication S56-123869), Patent Publication 2 (JP Laid-Open Patent Publication S57-208255), and Patent Publication 3 (JP Laid-Open Patent Publication S57-208256). In the ink jet recording head, disclosed in the Patent Publications 1 to 3, a plural number of nozzles, each including an ink flow duct and an orifice part, are patterned with e.g. a photosensitive resin material or a photoresist, on a substrate carrying a plural number of ink ejecting pressure generating devices. On a component part, carrying the ink flow ducts and the orifice parts, there is bonded a lid formed by, for example, a glass plate. Examples of the photosensitive resin material or the photoresist include diazo resin, p-diazoquinone, photo-polymerized photopolymers, containing vinyl monomers and a polymerization initiator, dimerized photopolymers, employing e.g. polyvinyl cinnamate and a sensitizer, a mixture of orthoquinone diazide and a phenol novolak resin, and a mixture of polyvinyl alcohol and diazo resin. Other examples include polyether photopolymers, obtained on copolymerization of 4-glycidyl ethylene oxide with benzophenone or glycidyl calcone, an N—N— dimethyl methacryl amide-acrylamide benzophenone copolymer, unsaturated polyester based photosensitive resin, unsaturated urethane-based photosensitive resin, and a photosensitive composition obtained on mixing a difunctional acrylic monomer with a photopolymerization initiator and a polymer. Further examples include a dichromate photoresist, a non-chromium-based water-soluble photoresist and a polyvinyl cinnamate based photoresist.

Other ink jet recording heads, satisfying the aforementioned conditions for ejecting, may be exemplified by an ink jet recording head, obtained by a method for preparation as disclosed in Patent Publication 4 (JP Laid-Open Patent Publication S61-154947), indicated below. In the method for the preparation of the ink jet recording head, disclosed in the Patent Publication 4, a plural number of ink flow duct patterns are formed on the site of the substrate, which become to be ink flow ducts, with a dissolvable resin, and the so formed ink flow duct patterns are coated with an epoxy resin. The substrate is then severed, and the dissolvable resin, which forms the ink flow duct patterns, is dissolved and removed to yield an ink jet recording head.

There is also such an ink jet recording head in which, in contrast to those shown in the Patent Publications 1 to 4, a plural number of electrical thermal transducers, as the ink ejecting pressure generating devices, are mounted facing the ejecting orifices, with the direction of growth of the air bubbles, formed on the electrical thermal transducers, being substantially the same as the ink ejecting direction. Examples of this type of the ink jet recording head are disclosed in the Patent Publication 5 (JP Laid-Open Patent Publication S58-8658) and Patent Publication 6 (JP Laid-Open Patent Publication S62-264957), indicated below. In the ink jet recording head, disclosed in Patent publication 5, a dry film, which later becomes an orifice plate, is bonded on a substrate, provided with the electrical thermal transducers, with another patterned dry film. A plural number of ejecting orifices are formed by a photolithographic technique on the sites facing the electrical thermal transducers of the dry film and which later become an orifice plate. In the ink jet recording head, disclosed in Patent Publication 6, the substrate, carrying the ink ejecting pressure generating devices, and an orifice plate, prepared by electrocasting, are bonded together via a patterned dry film.

Moreover, in the ink jet recording heads, it is necessary not only to eject the ink with the same volume and at the same ejecting speed via ink ejecting orifice but also to eject fine ink droplets at accurately set positions. In order for the ink jet recording head to eject the ink at these accurately set locations, the distance between the electrical thermal transducer and the ejecting orifice, referred to below as ‘OH’ distance, is desirably as short as possible.

An illustrative method for producing an ink jet recording head, the OH distance of which has been set to high accuracy, is disclosed in Patent Publication 7 (JP Laid-Open Patent Publication H6-286149). In this Patent Publication 7, there is disclosed a method for preparation of an ink jet recording head including an ink flow duct pattern forming step, a coating resin layer forming step and a dissolvable resin layer dissolving step. In the ink flow duct pattern forming step, an ink flow duct pattern, which later becomes an ink flow duct, is formed by a dissolvable resin on a substrate already carrying ink ejecting pressure generating devices. In the coating resin layer forming step, the coating resin, containing an epoxy resin, solid at ambient temperature, is dissolved in a solvent and applied by solvent coating on a dissolvable resin layer, forming an ink flow duct pattern, to form a coating resin layer, which later becomes a wall section of an ink flow duct, on the dissolvable resin layer. In the resin layer dissolving step, the dissolvable coating layer, forming the ink flow duct pattern, is dissolved. In the method for producing an ink jet recording head, described in Patent Publication 7, a cationic polymer of an alicyclic epoxy resin is used as the coating resin from the viewpoint of forming a high aspect ratio pattern and of assuring high resistance against the ink.

### SUMMARY OF THE INVENTION

In the ink jet recording head, disclosed in the Patent Publications 1 to 4, a plural number of heater resistors, provided in preset portions of the ink flow ducts to become ink ejecting pressure generating devices, are mounted along a line parallel to the ink flow direction. The ink ejecting orifices are provided at terminal parts of the ink flow ducts for extending at right angles to the ink flow direction. In this type of the ink jet recording head, since the ink ejecting orifices are arranged substantially at right angles to the line of the heater resistors, the ink ejecting direction is perpendicular to the direction of growth of air bubbles on the resistor heaters, that is, the direction of growth of the air bubbles differs from the direction of ink emission.

In the ink jet recording heads, since a portion of the ejecting orifice, disposed at a terminal end of the ink flow duct, is formed by the terminal end of the substrate, the distance between the ink ejecting pressure generating device and the ejecting orifice is set as a result of severing the substrate. Thus, in controlling the distance between the ink ejecting pressure generating device and the ejecting orifice, the accuracy with which the substrate is severed is critical. The practice in severing a substrate is to use a mechanical device, such as a dicing saw. However, with this mechanical device, it is difficult to realize the high accuracy desired.

In the ink jet recording heads, disclosed in these Patent Publications 5 and 6, the orifice plates are of a thin thickness of, for example, 20 μm or less. Moreover, it is difficult to fabricate the orifice plate to a uniform thickness. Even granting that the orifice plate has been prepared, it is extremely difficult to join the orifice plate to the substrate, already carrying the ink ejecting pressure generating devices, because of fragility of the orifice plate.

On the other hand, in the ink jet recording head, the following problems have newly been met due to use of the methods and the materials disclosed in Patent Publication 7 and Patent Publication 8 (JP Laid-Open Patent Publication H7-214783).

The cured cationic polymer of the alicyclic epoxy resin has a high bonding power with respect to the underlying substrate. However, the polymer has high inner stress and hence is likely to peel off from the underlying substrate. Moreover, the polymer is subjected to cracking (film cleavage) in a corner portion where stress concentration is likely to be produced, thus severely detracting from the reliability of the ink jet recording head. In addition, among the materials, disclosed in the above Patent Publications, there are many materials which are insufficient in the patterning performance and with which the delicate patterning performance, necessary for the ink jet recording head structures, may not be achieved.

In the ink jet recording head, the coating resin layer tends to be peeled off or cracked, especially in case the resin layer is of an elongated length, in case the coating resin layer, operating as ink flow duct wall section, is thicker in thickness, or in case the ink flow duct presents an intricate or complicated structure. Moreover, in the ink jet recording head, the operation of cleaning the surface of the head, from which the ink is ejected, for removing excess ink affixed to the recording head, may not be dispensed with, in order to maintain the printing quality. In cleaning the ink jet recording head, the head surface is wiped with a cleaning member. Hence, there is applied mechanical load on the head surface, as a result of which the coating resin layer is apt to peel off from the substrate.

Hence, it is desirable to provide a flow duct forming material for a liquid emission recording head which is low in stress and which has a coating film which allows for accurate and facilitated pattern shaping by for example irradiation of ultraviolet rays.

According to an embodiment of the present invention, there is provided a flow duct forming material for a liquid ejecting recording head, which includes an oxetane resin composition that contains, as necessary components, an oxetane compound having at least one oxetanyl group in a molecule, and a cationic photopolymerization initiator.

According to the present invention, in which an oxetane resin composition is contained in a flow duct forming material of a liquid ejecting recording head, the coated resin layer may be reduced in the stress, from characteristics as a low stress material proper to the oxetane compound, to prevent cracking and exfoliation from the substrate of the coated resin layer. This gives a liquid ejecting recording head exhibiting superior durability. Moreover, according to the present invention, resistance against chemicals may be obtained by forming the coated resin layer of the oxetane resin composition. Thus, according to the present invention, a liquid ejecting recording head may be obtained which is improved in manufacture yield and product quality and which also exhibits high reliability for an extended period of time.

### BRIEF DESCRIPTION OF THE DRAWINGS

FIG. 1 is a perspective view of an ink jet recording head according to an embodiment of the present invention.

FIG. 2 is a cross-sectional view showing the state in which an emission energy generating device and an ink supply orifice have been provided in a substrate.

FIG. 3 is a cross-sectional view showing the state in which a resin layer has been formed on a substrate.

FIG. 4 is a cross-sectional view showing the state in which activation energy rays are being illuminated on a resin layer formed on the substrate.

FIG. 5 is a cross-sectional view showing the state in which an ink flow duct wall section has been formed on the substrate.

FIGS. 6A and 6B show an ink jet recording head, with FIG. 6A schematically showing, in cross-section, the state in which an air bubble has been generated on an emission energy generating device, and FIG. 6B schematically showing the state in which the ink is being ejected from a nozzle.

### DESCRIPTION OF THE PREFERRED EMBODIMENTS

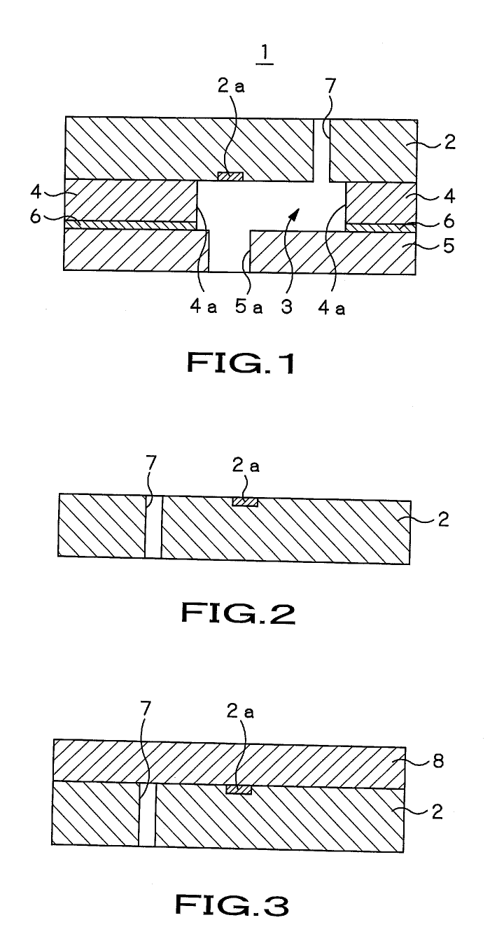

Referring to the drawings, a flow duct forming material for a liquid ejecting recording head according to an embodiment of the present invention will now be explained. The flow duct forming material of a liquid ejecting recording head is a material which makes up an ink flow duct of an ink jet recording head provided in an ink jet printer adapted for ejecting the ink as a liquid. Referring to FIG. 1, an ink jet recording head 1 is provided with a substrate 2, carrying an emission energy generating device 2a, a flow duct forming member 4, forming an ink flow duct 3, supplying the ink i to around the emission energy generating device 2a, and a nozzle sheet 5, carrying a nozzle 5a adapted for ejecting the ink i. The nozzle sheet 5 is bonded with an adhesive layer 6 to the surface of the flow duct forming member 4 opposite to the surface thereof carrying the substrate 2. In the ink jet recording head 1, a nozzle 5a is provided at a location facing the emission energy generating device 2a with the ink flow duct 3 in-between.

The substrate 2 is e.g. a silicon substrate, on a preset surface area of which there is formed an electrical thermal transducer, as the emission energy generating device 2a, by a semiconductor manufacturing process. There is also formed on the substrate 2 a control circuit, not shown, for controlling the emission energy generating device 2a.

Referring to FIG. 1, an end face of the flow duct forming member 4 towards the ink flow duct 3 becomes a flow duct wall section 4a, and forms a part of the ink flow duct 3 along with the substrate 2 and the nozzle sheet 5. The flow duct forming member 4 is obtained on curing a flow duct forming material including an oxetane resin composition that contains, as necessary components, an oxetane compound having at least one oxetanyl group in a molecule, and a cationic photopolymerization initiator.

The oxetane compound, forming an oxetane resin composition in the flow duct forming material, has a four-membered ring which is an oxirane ring of an epoxy plus one carbon atom. The oxetane compound exhibits cationic curing properties higher than those of the epoxy compound. The cured cationic polymer of this oxetane compound has a molecular weight much larger than that of the cured epoxy polymer and is capable of exhibiting high tenacity, elongation, highly reliable mechanical strength, higher water-proofness and higher resistance against chemicals. The features of the cured cationic polymer of this oxetane compound differ significantly from those of the cured epoxy polymer which is hard and brittle. On the other hand, the cured cationic polymer of the oxetane compound does not exhibit mutation inducing action ascribable to the four-membered oxetanyl group and is superior in safety to the photo-curable epoxy resin.

There are two types of the oxetane compound, namely a monofunctional oxetane compound having a single oxetanyl group in a molecule and a polyfunctional oxetane compound having two or more oxetanyl groups in a molecule. The monofunctional oxetane compound is represented by the following general formula (1):

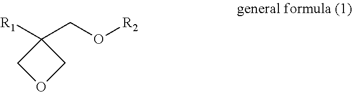

In the general formula (1), R1 denotes a hydrogen atom, a C1 to C6 alkyl group, such as a methyl group, an ethyl group, a propyl group or a butyl group, a C1 to C6 fluoroalkyl group, an allyl group, an aryl group, a furil group or a thienyl group. R2 denotes a C1 to C6 alkyl group, such as a methyl group, an ethyl group, a propyl group or a butyl group, a C2 to C6 alkenyl group, such as a 1-propenyl group, a 2-propenyl group, a 2-methyl-1-propenyl group, a 2-methyl-2-propenyl group, a 1-buthenyl group, a 2-buthenyl group or a 3-buthenyl group, a group having an aromatic ring, such as a phenyl group, a benzyl group, a fluorobenzyl group, a methoxybenzyl group or a phenoxyethyl group, a C2 to C6 alkyl carbonyl group, such as an ethyl carbonyl group, a propyl carbonyl group or a butyl carbonyl group, a C2 to C6 alkyl carbonyl group, such as an ethyl carbonyl group, a propyl carbonyl group or a butyl carbonyl group, a C2 to C6 alkoxy carbonyl group, such as an ethoxy carbonyl group, a propoxy carbonyl group or a butoxy carbonyl group, or a C2 to C6 N-alkyl carbamoyl group, such as an ethyl carbamoyl group, a propyl carbamoyl group, a butyl carbamoyl group or a pentyl carbamoyl group.

The difunctional oxetane compound, having two oxetanyl groups, may be represented by the following general formulas (2) and (3):

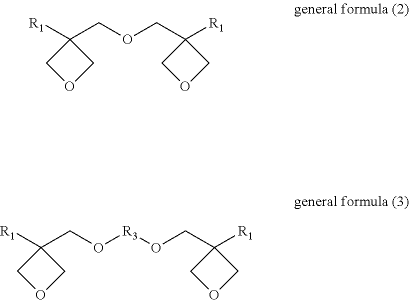

In the general formula (2), R1 has the same meaning as in the general formula (1).

In the general formula (3), R1 has the same meaning as in the general formula (1). R3 is a divalent group selected from the group composed of C1-C12 straight-chained or branched saturated hydrocarbons, C1-C12 straight-chained or branched unsaturated hydrocarbons, aromatic hydrocarbons, represented by the following formulas (A) to (E):

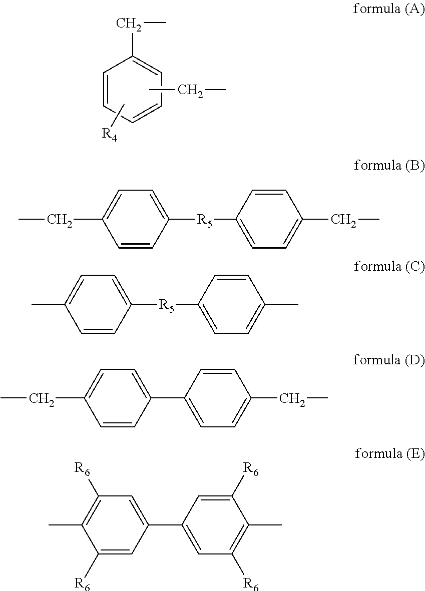

straight-chained or cyclic alkylenes, having carbonyl groups, represented by the formulas (F) and (G):

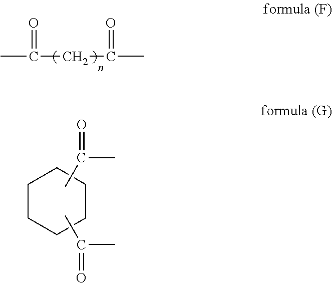

and aromatic hydrocarbons, containing carbonyl groups, represented by the formulas (H) and (I):

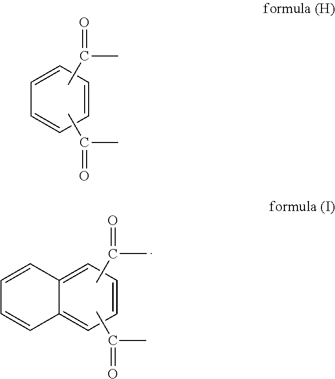

As other difunctional oxetane compounds, there are caldo type compounds and naphthalene type compounds.

In the formulas (A) to (E), R4 denotes a hydrogen atom, a C1-C12 alkyl group, an aryl group or an aralkyl group, R5 denotes —O—, —S—, —CH₂—, —NH—, —SO₂—, —CH(CH₃)—, —C(CH₃)₂—, or —C(CF₃)₂— and R6 denotes a hydrogen atom or a C1-C6 alkyl groups.

In the formula (F), n denotes an integer not less than 1.

The tri-functional or higher functional oxetane compounds may be enumerated by phenol-novolak oxetane compounds, represented by the general formula (4), cresol-novolak oxetane compounds, represented by the general formula (5), and by oxetane compounds, having triazine skeletons, represented by the general formulas (6) and (7).

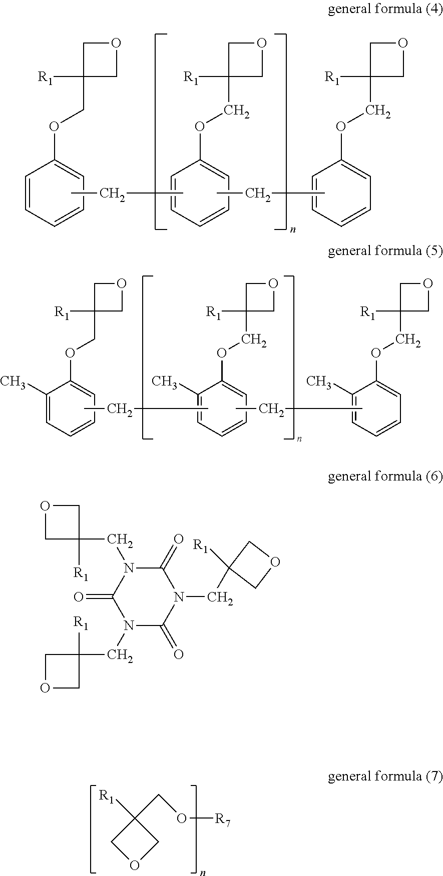

Other tri-functional or higher functional oxetane compounds may be enumerated by poly(hydroxylstyrene), calixarenes, etherified compounds with hydroxyl group containing silicone resins, such as silsesquioxane, and a copolymer of an unsaturated monomer including an oxetane ring with alkyl(meth)acrylate.

In the general formulas (4) and (5), R1 is the same as that in the general formula (1) and n denotes an integer not less than 1. In the novolak oxetane compounds, the number of the number average skeletons is preferably 3 to 10, with n being 1 to 8. If the number of the number average skeletons exceeds 10, the viscosity value becomes higher and the density of the cross-linkage is not increased due to steric hindrance.

In the general formula (6), R1 has the same meaning as in the general formula (1).

In the general formula (7), R1 has the same meaning as in the general formula (1). R7 is a C1-C12 branched alkylene group represented by the following formulas (J), (K) and (L) or aromatic hydrocarbons represented by the following formulas (M), (N) and (P), and n denotes the number of the functional groups, linked to R7, as indicated in the general formula (7).

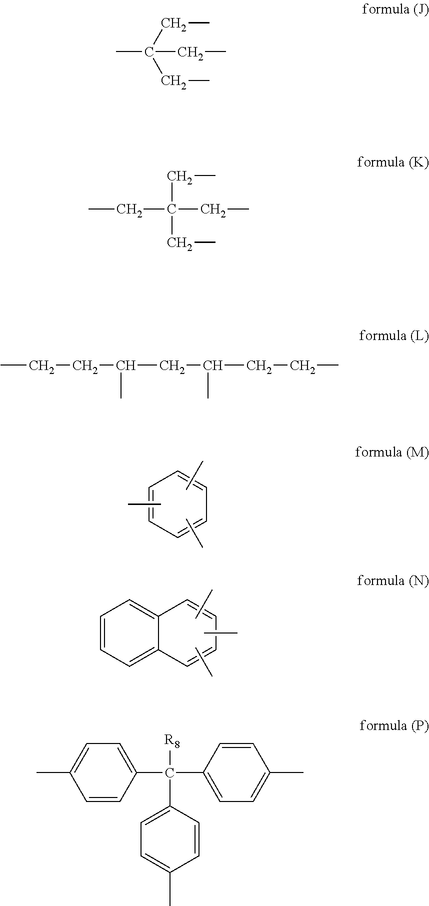

In the formula (P), R8 denotes a hydrogen atom, a C1-C6 alkyl group or an aryl group.

These oxetane compounds are used either singly or as a mixture. In case stronger resistance against chemicals or higher durability is desirable, it is preferred to use polyfunctional oxetane compounds. In case desired viscosity may not be obtained with use of the polyfunctional oxetane compounds, these may be diluted with monofunctional oxetane compounds.

The oxetane compounds ultimately yield a cured compound exhibiting a high cationic curing degree. The rate of curing at the initial reaction stage may be increased by addition of a moderate quantity of an epoxy compound or a vinyl ether compound. The amount of addition in this case is preferably 5 wt % to 95 wt % as referred to the oxetane compound.

In case the flow duct forming member 4 is formed of the oxetane resin composition, a cationic polymerization initiator is contained, in addition to the above-mentioned oxetane compound, in the oxetane resin composition. In case activation energy rays, such as ultraviolet rays, are illuminated on the flow duct forming material, for patterning, cationic photopolymerization initiators are used. The cationic photopolymerization initiators may be used either singly or in combination.

Examples of the commercially available cationic photopolymerization initiators include CYRACURE UV1-6950 and UVI-6970, manufactured by Union Carbide Corporation, Optomer-SP-150, SP-151, SP-152, SP-170 and SP-171, manufactured by Asahi Denka Kogyo K.K., CI-2855, manufactured by NIPPON SODA CO., LTD., and triaryl sulfonium salts, such as Degacere KI85B, manufactured by Degussa Inc., unsaturated or saturated aryl diazonium salts and diaryl iodonium salts. The sulfonic acid derivative may be PAI-101 manufactured by Midori Kagaku Co., Ltd.

The proportion of the cationic photopolymerization initiator is preferably 2 to 40 parts by weight based on 100 parts by weight of the oxetane compounds. If the proportion of the cationic photopolymerization initiator is lesser than 2 parts by weight, the amount of an acid, generated on irradiation of the activation energy rays, is only small, such that difficulties may be met in patterning. If conversely the proportion of the cationic photopolymerization initiator is more than 40 parts by weight, the cationic photopolymerization initiator itself tends to absorb light to lower the sensitivity. If desired to improve the curing degree further, it is possible to use a cationic heat polymerization initiator or a cationic photosensitizer in combination.

By employing the flow duct forming material, described above, for the flow duct forming member 4, making up the ink flow duct 3, high mechanical strength, along with high tenacity and high elongation, may be achieved by the oxetane resin composition that contains, as necessary components, an oxetane compound having at least one oxetanyl group in a molecule, and a cationic photopolymerization initiator. Thus, it becomes possible to prevent inconveniences such as cracking of the flow duct forming member 4 or exfoliation thereof from the substrate 2, with the result that the ink jet recording head 1 improved in manufacture yield or quality may be produced. Moreover, the cured material of the epoxy resin is lower in the stress than the cured material of the epoxy resin, so that it becomes possible to prevent the flow duct forming member 4 from peeling off from the substrate 2 more effectively than in case the flow duct forming member 4 is formed of a cured material of the epoxy resin. Additionally, the flow duct forming member 4 may be higher in water-proofness or resistance against chemicals by its content of the oxetane resin composition.

The flow duct forming material, formed of the oxetane compound and the cationic photopolymerization initiator, may be added by any of a variety of additives, as necessary, besides the oxetane resin composition composed of the aforementioned oxetane compounds and the cationic photopolymerization initiator. Preferred as such additives are coupling agents for further improving the tightness in affixture between the oxetane resin composition and the substrate 2. As such coupling agents, aluminate-, titanate-, zirconate- or silane-based coupling agents may selectively be used. Of these, the silane-based coupling agents are most desirable.

Examples of the aluminate-based coupling agents include acetoalkoxy aluminum diisopropylate, aluminum diisopropoxy monoethyl acetoacetate, aluminum trisethyl acetoacetate and aluminum trisacetyl acetonate.

Examples of the titanate-based coupling agents include isopropyl tristearoyltitanate, isopropyl tris(dioctylpyrophosphate)titanate, isopropyl tri(N-aminoethyl.aminoethyl)titanate, tetraoctyl bis(ditridecylphosphate)titanate, tetra(2-2 diallyloxymethyl-1-butyl)bis(ditridecyl)phosphate titanate, bis(dioctyl pyrophosphate)oxyacetate titanate and bis(dioctyl pyrophosphate)ethylene titanate.

Examples of the zirconate-based coupling agents include zirconium tetrakisacetyl acetonate, zirconium dibutoxy bisacetyl acetonate, zirconium tetrakisethyl acetoacetate, zirconium tributoxy monoethyl acetoacetate and zirconium tributoxy acetylacetonate.

Examples of the silane-based coupling agents include vinyl trimethoxysilane, vinyl triethoxysilane, 2-(3,4 epoxycyclohexyl)ethyl trimethoxysilane, 3-glycidoxy propyl trimethoxysilane, 3-mercaptopropyl trimethoxysilane, 3-methacryloxy propyl trimethoxysilane, 3-glycidoxy propylmethyl dimethoxysilane, 3-chloropropyl trimethoxysilane and 3-isocyanate propyl triethoxysilane.

Of the silane-based coupling agents, amino-based coupling agents absorb acids derived from the cationic photopolymerization initiator to lower the sensitivity, and hence are not desirable. The amount of addition of the additive is not less than 0.1 wt % and less than 1 wt %, referred to the flow duct forming material in its entirety. If the amount of addition is less than 0.1 wt %, the favorable effect on tightness in affixture is only low, whereas, if the amount of addition is not less than 1 wt %, the rate of development is lowered appreciably, such that development residues tend to be produced, or the resolution may be lowered.

If, in case the oxetane resin composition is used for the flow duct forming member 4 of the ink jet recording head 1, an optimum coupling agent, that is, the silane-based coupling agent, is used, the bonding strength on the boundary surface between the substrate 2, mainly composed of inorganic components, and the oxetane resin composition, composed of an organic material, may be improved. Hence, even though the first coating resin layer is exposed to the ink i, the flow duct forming member may be maintained in a tightly bonded state with respect to the substrate 2, thus leading to improved operational reliability of the ink jet recording head 1.

The oxetane resin composition, used in forming the flow duct forming member 4, may be in a state dissolved in a solvent. By using the oxetane resin composition dissolved in a solvent, optimum viscosity and coating properties may be obtained when coating the flow duct forming member 4 to a necessary film thickness on the substrate 2.

It is sufficient that the solvent used is capable of dissolving the oxetane compound or an additive(s) used. Examples of the solvents that may be used include ketones, such as methylethylketone or cyclohexanone, aromatic hydrocarbons, such as toluene, xylene or tetramethylbenzene, and glycol ethers, such as cellosolve, methyl cellosolve, butyl cellosolve, carbitol, methyl carbitol, butyl carbitol, propylene glycol monomethylether, propylene glycol monoethylether, dipropylene glycol diethylether or triethylene glycol monoethylether. Other examples of the solvents used include acetates, such as ethyl acetate, butyl acetate, cellosolve acetate, butyl cellosolve acetate, carbitol acetate, butyl carbitol acetate, propylene glycol monomethylether acetate, or dipropylene glycol monomethylether acetate, alcohols, such as ethanol, propanol, ethylene glycol or propylene glycol, aliphatic hydrocarbons, such as octane or decane, petroleum-based solvents, such as petroleum ether, petroleum naphtha, hydrogenated petroleum naphtha or solvent naphtha, and terpenes, such as limonene. Of these solvents, the aromatic hydrocarbons, such as xylene or toluene, may be used to give optimum solubility for the oxetane resin composition.

The method for producing the ink jet recording head 1, in which the flow duct forming member 4 is formed of the flow duct forming material, containing the oxetane resin composition, described above, will now be described.

Initially, a silicon (Si) substrate is provided as a substrate 2, as shown in FIG. 2. On a preset area of the surface of this substrate 2, there is formed an electro-thermal transducing device, as an emission energy generating device 2a. In the substrate 2, there is formed an ink supply orifice 7 for supplying the ink i from an ink cartridge to an ink flow duct 3.

On the surface of the substrate 2, carrying the emission energy generating device 2a, there is formed a resin layer 8 to a thickness of, for example, ca. 12 μm, by a semiconductor manufacture process, as shown in FIG. 3. This resin layer 8 is formed of a flow duct forming material including an oxetane resin composition that contains, as necessary components, an oxetane compound having at least one oxetanyl group in a molecule, and a cationic photopolymerization initiator.

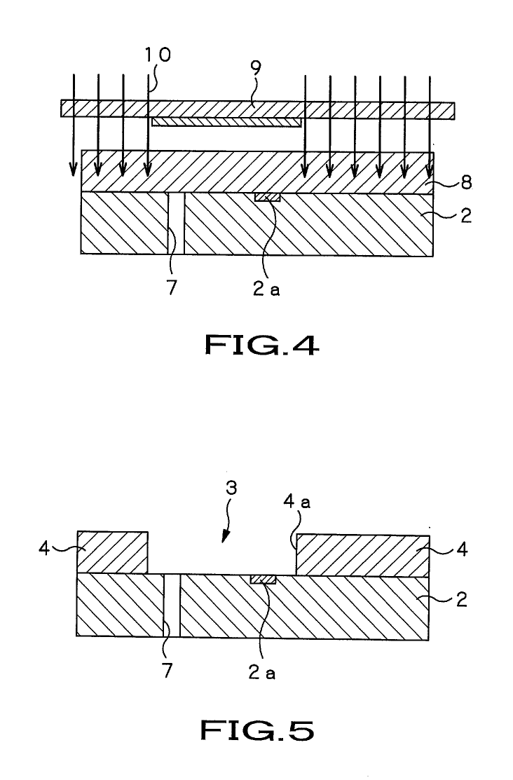

The resin layer 8 is then irradiated with activation energy rays 10, such as ultraviolet light (UV light), through a patterned mask 9 so that the activation energy rays 10 will not be illuminated on the ink flow duct forming site, for effecting light exposure with the activation energy rays 10, as shown in FIG. 4. The exposed portion of the resin layer 8 is cured and becomes insoluble in the developing solution, while its unexposed portion becomes soluble in the developing solution.

The unexposed portion of the resin layer 8 is then developed with a preset developing solution, not shown, to remove the unexposed portion of the resin layer 8, as shown in FIG. 5. The remaining portion of the resin layer 8 forms the flow duct forming member 4 having a flow duct wall section 4a forming a portion of the ink flow duct 3.

A nozzle sheet 5, including a nozzle 5a substantially in register with the ink flow duct 3, and carrying a thin heat curing adhesive layer 6 on the side to be bonded to the flow duct forming member 4, is then bonded to the flow duct forming member 4, as shown in FIG. 1. The nozzle sheet 5 is bonded to the flow duct forming member 4, with the aid of pressure and heat in combination, as adjustment is made of the position relationship between the nozzle 5a and the emission energy generating device 2a. By bonding the nozzle 5 to the flow duct forming member 4, there may be obtained an ink jet recording head 1 in which there has been formed an ink flow duct 3 delimited by the substrate 2, flow duct forming member 4 and the nozzle sheet 5.

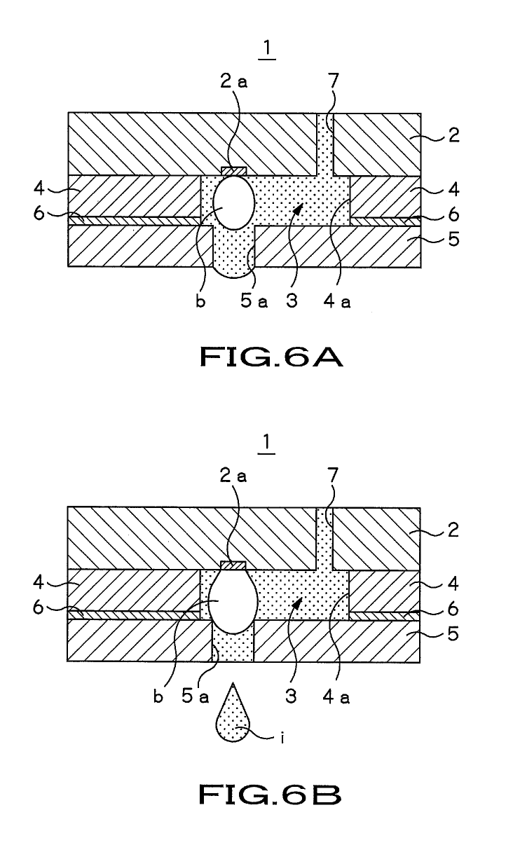

In the ink jet recording head, described above, if the pulse current is supplied to the emission energy generating device 2a to rapidly heat the emission energy generating device 2a, as shown in FIGS. 6A and 6B, an air bubble b is generated in the portion of the ink i contacted with the emission energy generating device 2a, as shown in FIG. 6A. In the ink jet recording head, the air bubble b is expanded to pressurized the ink i, so that the ink i, thus pressurized, is ejected from the nozzle 5a as a liquid droplet, as shown in FIG. 6B. After the ink i has been ejected as a liquid droplet, the ink i is supplied from the ink supply orifice 7 into the ink flow duct 3 to resume the pre-emission state of the ink jet recording head 1.

The ink jet recording head 1, in which an oxetane resin composition that contains, as necessary components, an oxetane compound having at least one oxetanyl group in a molecule, and a cationic photopolymerization initiator is used as a flow duct forming material, undergoes only little contraction, at the time of curing, such that high mechanical strength as well as high tenacity and elongation may be developed to assure high operational reliability. When the head is cleaned, such that mechanical load is applied to the head surface, there is no risk that the flow duct forming member 4 peels off from the substrate 2 or undergoes cracking. Moreover, the ink jet recording head 1, in which a flow duct forming material containing the oxetane resin composition is used as the flow duct forming member 4, is rendered water-proof and resistant against chemicals. Furthermore, since the flow duct forming material, formed of the oxetane resin composition, also contains an additive, tightness in affixture may be maintained between the substrate 2 and the flow duct forming member 4 even on contact with the ink i, thus assuring high operational reliability of the present ink jet recording head 1 for prolonged time.

Moreover, in the ink jet recording head 1, the flow duct forming member 4 may be elongated or increased in thickness, through the use of the flow duct forming material of the oxetane resin composition for the flow duct forming member 4. In addition, the ink flow duct 3 of complex or intricate structure may be formed with ease to high accuracy.

Meanwhile, in the ink jet recording head 1, described above, electro-thermal transducers are used as the emission energy generating device 2a. This is merely illustrative and, for example, an electro-mechanical transducing system, employing an electro-mechanical transducing device, such as a piezo device, may also be used for ejecting the ink i from the nozzle.

In the foregoing, the present invention is applied to a printer. However, this is merely illustrative and the present invention may be applied to a large variety of other liquid ejecting devices, such as facsimile or copying devices.

### EXAMPLES

The following shows the results of researches into physical properties of the flow duct forming material, and the results of evaluation of the resistance against the ink and printing performance of the ink jet recording head, prepared with the use of the flow duct forming member.

<Researches into Physical Properties of the Oxetane Resin Composition>

The following experiments were conducted for scrutinizing into the problem inherent in the resin, that is, the post-curing inner stress of the resin. The inner stress was checked by observing the pre-curing film thickness and the post-curing film thickness of the resin layer. If the two film thicknesses are equal, it may be presumed that the inner stress caused by volumetric changes accompanying the curing of the resin is extremely small.

### Example 1

In Example 1, a flow duct forming material containing an oxetane resin composition, shown in the following Table 1, was spin-coated on a 6-inch wafer. The resulting product was pre-baked on a hot plate at 90° C. for five minutes. Coating was then made to a film thickness of 20 μm and exposed to light by a mirror projection light exposure device (MPA 600 FA manufactured by Canon Inc.) to 1 J/cm². After post baking on a hot plate at 90° C. for five minutes, the resulting product was cured at 200° C. for one hour to produce a cured film of the oxetane resin composition.

TABLE 1

| | | |
|---|---|---|
| phenol novolak oxetane compound (average | 100 | parts by weight |
| number of basic structures: 3) | | |
| cationic photopolymerization initiator (SP-170 | 2 | parts by weight |
| manufactured by Asahi Denka Kogyo K.K.) | | |
| silane coupling agent (2-(3,4 epoxy cyclohexyl) | 0.5 | part by weight |
| ethyl trimethoxysilane | | |
| organic solvent (petroleum naphtha: IPSOL150 | 100 | parts by weight |
| manufactured by Idemitsu Kosan Co., Ltd) | | |

### Comparative Example 1

In the Comparative Example 1, a cured film of an alycyclic epoxy resin composition was obtained in the same way as in Example 1, using a solution containing the alicyclic epoxy resin composition shown in the following Table 2.

TABLE 2

| | | |
|---|---|---|
| alicyclic epoxy resin (EHPE-3150: DICEL | 100 | parts by weight |
| CHEMICAL INDUSTRIES, LTD.) | | |
| cationic photopolymerization initiator (SP-170 | 2 | parts by weight |
| manufactured by Asahi Denka Kogyo K.K.) | | |
| silane coupling agent (2-(3,4 epoxy cyclohexyl) | 0.5 | part by weight |
| ethyl trimethoxysilane | | |
| organic solvent (xylene) | 100 | parts by weight |

Of the cured films, obtained in Example 1 and in Comparative Example 1, film thicknesses after curing on a hot plate at 200° C. for one hour were measured. The results of measurement indicated that, while the film thicknesses were not decreased with the cured films containing the oxetane resin composition shown in Table 1, the film thicknesses were decreased with the cured films containing the alicyclic epoxy resin composition shown in Table 2.

The stress in the respective cured films was then measured, using a thin film stress measurement device. It was seen that the stress in the cured films containing the oxetane resin composition shown in Table 1 was decreased appreciably as compared to that in the cured films containing the alicyclic epoxy resin composition shown in Table 2.

### <Evaluation of Resistance Against Ink and Printing Performance of the Ink Jet Recording Head>

### Example 2

In the Example 2, the ink jet recording head 1 was prepared in the following manner. Initially, a silicon (Si) substrate, on a preset area of which was formed an electro-thermal transducing device, as an emission energy generating device 2a, was provided as shown in FIG. 2. In the substrate 2, there was formed an ink supply orifice 7 for supplying the ink i from an ink cartridge to the ink flow duct 3.

On the surface of the substrate 2, carrying the emission energy generating device 2a, there was formed a resin layer 8 to a thickness of, for example, ca. 12 μm, by a semiconductor manufacture process, as shown in FIG. 3. This resin layer 8 was formed of a flow duct forming material including an oxetane resin composition that contains, as necessary components, an oxetane compound having at least one oxetanyl group in a molecule, and a cationic photopolymerization initiator.

The resin layer 8 was then irradiated with activation energy rays 10, such as ultraviolet light (UV light), through a patterned mask 9, so that the activation energy rays 10 will not be illuminated on the ink flow duct forming site, for effecting light exposure with the activation energy rays 10, as shown in FIG. 4. The exposed portion of the resin layer 8 was cured and turned insoluble in the developing solution, while its unexposed portion was turned soluble in the developing solution.

The unexposed portion of the resin layer 8 was then developed with a preset developing solution, not shown, to remove the unexposed portion of the resin layer 8, as shown in FIG. 5. The remaining portion of the resin layer 8 formed the flow duct forming member 4 having the flow duct wall section 4a forming a portion of the ink flow duct 3.

The nozzle sheet 5, including the nozzle 5a substantially in register with the ink flow duct 3 and carrying a thin heat curing adhesive layer 6 on the side to be affixed to the flow duct forming member 4, was then affixed to the flow duct forming member 4, as shown in FIG. 1. The nozzle sheet 5 was affixed to the flow duct forming member 4, with the aid of pressure and heat in combination, as adjustment was made of the position relationship between the nozzle 5a and the emission energy generating device 2a. By bonding the nozzle 5 to the flow duct forming member 4, an ink jet recording head 1 was prepared in which there was formed an ink flow duct 3 delimited by the substrate 2, flow duct forming member 4 and the nozzle sheet 5.

### Comparative Example 2

In the Comparative Example 2, an ink jet recording head 1 was prepared in the same way as in Example 1, except using, as a material of the flow duct forming member 4 forming the ink duct, a flow duct forming material containing the alicyclic epoxy resin composition shown in Table 2.

The ink jet recording heads 1 of the Example 2 and the Comparative Example 2 were immersed in black ink at 60° C. for one week by way of an ink immersion test. As the black ink, an ink composed of pure water, ethylene glycol and black dye, manufactured by Sony Corporation for LPR-5000, was used.

The results of the ink immersion test indicated that, with the ink jet recording head 1 of Example 1, in which the flow duct forming member 4 was formed of the oxetane resin composition, shown in Table 1, such changes as peeling off of the flow duct forming wall section 4a from the substrate 2 were not observed. Conversely, with the ink jet recording head 1 of the Comparative Example 2, in which the flow duct forming member 4 was formed of the alicyclic epoxy resin composition, shown in Table 2, it was seen that the flow duct forming member 4 partially peeled off, after the immersion in the ink, possibly due to the stress ascribable to the curing.

As for evaluation of the printing performance, about 20,000 print patterns for confirming the dignity of the printed letter were consecutively printed on the ink jet recording heads 1 of the Example 2 and the Comparative Example 2 for evaluating the print quality. With the prints by the ink jet recording head 1 of Example 2, no degradation of the print quality, thought to be attributed to the flow duct forming member 4, was observed. Conversely, with the prints obtained with the ink jet recording head 1 of the Comparative Example 2, deterioration of the print quality, thought to be attributed to the peeling of the flow duct forming member 4, could be observed.

It may be seen from above that, by forming the flow duct forming member 4, making up the ink flow duct 3, from the flow duct forming material containing the oxetane resin composition, according to the embodiment of the present invention, the ink flow duct 3 of high durability could be produced in which the inner stress and exfoliation from the substrate 2 could be reduced based upon characteristics of the flow duct forming material as a low stress material proper to the oxetane resin. From this it may be seen that an ink jet recording head which may exhibit high operational reliability for prolonged time may be produced with the use of the flow duct forming member 4 formed of this flow duct forming material.

It should be understood by those skilled in the art that various modifications, combinations, sub-combinations and alterations may occur depending on design requirements and other factors insofar as they are within the scope of the appended claims or the equivalents thereof.

What is claimed is:

1. An inkjet recording head, comprising:
a substrate with an orifice in communication with a supply of ink; and
a flow duct layer secured to the substrate, the flow duct layer having a void therein defining a flow duct, the flow duct being in fluid communication with the orifice,
wherein,
the flow duct layer is made of an oxetane resin comprising (a) a polyfunctional oxetane compound having at least two oxetanyl groups in a molecule, (b) a cationic photopolymerization initiator in the amount of 2-40 parts by weight based on 100 parts by weight of the oxetane compound, and (c) a silane coupling agent in the amount of 0.1 wt % and less than 1.0 wt % with reference to an entirety of the flow duct forming material.

2. The inkjet head of claim 1, wherein the oxetane compound contains an aromatic ring in a molecule.

3. The inkjet head of claim 1, wherein the skeleton of the oxetane compound is of a novolak type.

4. The inkjet head of claim 3, wherein the number of the number of averaged basic structures is 3 to 10.

5. A method of forming an inkjet head comprising the steps of:
providing a silicon substrate;
forming an electro-thermal transducing device at a first surface of the substrate;
forming an ink supply orifice extending through the substrate;
forming a resin layer over the first surface of the substrate;
selectively exposing a portion of the resin layer with activation energy rays by irradiating the resin layer while using a patterned mask such that an unexposed portion of said resin layer that is not irradiated by the activation energy rays becomes soluble in a developing solution whereas an exposed portion of the resin layer irradiated by the activation energy rays become insoluble in the developing solution;
removing the unexposed portion of the resin layer using the developing solution;
securing a nozzle layer over the remaining exposed portion of the resin layer so as to form an ink flow duct out of the a space enclosed by the remain exposed portions of the resin layer, the substrate and the nozzle layer, in the ink flow duct being in fluid communication with the ink supply orifice and a nozzle opening in the nozzle layer, the electro-thermal transducing device being in registry with the nozzle opening,
wherein,
the resin layer is an oxetane resin comprising (a) a polyfunctional oxetane compound having at least two oxetanyl groups in a molecule, (b) a cationic photopolymerization initiator in the amount of 2-40 parts by weight based on 100 parts by weight of the oxetane compound, and (c) a silane coupling agent in the amount of 0.1 wt % and less than 1.0 wt % with reference to an entirety of the flow duct forming material

6. The inkjet head of claim 5, wherein the oxetane compound contains an aromatic ring in a molecule.

7. The inkjet head of claim 5, wherein the skeleton of the oxetane compound is of a novolak type.

8. The inkjet head of claim 7, wherein the number of the number of averaged basic structures is 3 to 10.
